(19) United States
(12) Patent Application Publication
(10) Pub. No.: US 2024/0175699 A1
(43) Pub. Date: May 30, 2024

(54) VEHICLE DISPLAY CONTROL DEVICE, VEHICLE DISPLAY CONTROL SYSTEM, VEHICLE, VEHICLE DISPLAY CONTROL METHOD, AND NON-TRANSITORY STORAGE MEDIUM STORING PROGRAM

(71) Applicant: TOYOTA JIDOSHA KABUSHIKI KAISHA, Toyota-shi (JP)

(72) Inventors: Masashi NOSE, Nagoya-shi (JP); Tomoaki MIYAZAWA, Nagoya-shi (JP); Kazuya KUMAZAWA, Nagoya-shi (JP); Miki TSUJINO, Nagakute-shi (JP); Tsukasa KITAZAWA, Toyota-shi (JP)

(73) Assignee: TOYOTA JIDOSHA KABUSHIKI KAISHA, Toyota-shi (JP)

(21) Appl. No.: 18/490,820

(22) Filed: Oct. 20, 2023

(30) Foreign Application Priority Data
Nov. 25, 2022 (JP) 2022-188773

(51) Int. Cl. G01C 21/36; B60K 35/00

(52) U.S. Cl. CPC G01C 21/3676; B60K 35/00; G01C 21/3694; B60K 2370/1529; B60K 2370/166; B60K 2370/52

(57) ABSTRACT

A vehicle display control device that determines whether or not a lane change is necessary based on at least one of a planned travel route or area conditions and, in a case in which a lane change is necessary, displays information relating to the lane change in a display area in a vicinity of a driver's seat, wherein the vehicle display control device varies the information displayed in the display area between a lane change with an object of passing a vehicle in front and lane changes with objects other than passing

### CROSS-REFERENCE TO RELATED APPLICATION

This application is based on and claims priority under 35 USC 119 from Japanese Patent Application No. 2022-188773 filed on Nov. 25, 2022, the disclosure of which is incorporated by reference herein.

### BACKGROUND

### Technical Field

The present disclosure relates to a vehicle display control device, a vehicle display control system, a vehicle, a vehicle display control method, and a non-transitory storage medium storing a program.

### Related Art

Japanese Patent Application Laid-open (JP-A) No. 2022-41288 discloses a display device which, before a vehicle changes lanes from a first lane in which it is driving to a second lane different from the first lane, causes a display unit provided in the cabin to display a lane display corresponding to the first lane and the second lane.

However, in the device disclosed in JP-A No. 2022-41288, when the vehicle changes lanes using a driver assistance function or the like, the object of the lane change cannot be distinguished at a glance, so there is room for improvement from the standpoint of allowing the occupant to quickly grasp the lane change situation.

### SUMMARY

The present disclosure provides a vehicle display control device, a vehicle display control system, a vehicle, a vehicle display control method, and a non-transitory storage medium storing a program, with which an occupant can quickly grasp a lane change situation.

A first aspect of the present disclosure is a vehicle display control device that determines whether or not a lane change is necessary based on at least one of a planned travel route or area conditions and, in a case in which a lane change is necessary, displays information relating to the lane change in a display area in a vicinity of a driver's seat, wherein the vehicle display control device varies the information displayed in the display area between a lane change with an object of passing a vehicle in front and lane changes with objects other than passing.

The vehicle display control device pertaining to the first aspect determines whether or not a lane change is necessary based on at least one of the planned travel route or the area conditions. Furthermore, in a case in which a lane change is necessary, the vehicle display control device displays the information relating to the lane change in the display area in the vicinity of the driver's seat. Because of this, when the vehicle performs a lane change using driver assistance or the like, the occupant can be notified that a lane change will be performed.

Furthermore, the vehicle display control device varies the information displayed in the display area between a lane change with the object of passing a vehicle in front and lane changes with objects other than passing. Because of this, the occupant can quickly grasp, just by checking the information displayed in the display area, whether or not the object of the lane change is passing.

In a second aspect of the disclosure, in the first aspect, the vehicle display control device may vary a display mode of the planned travel route of the vehicle between a lane change with the object of passing a vehicle in front and lane changes with objects other than passing.

In the vehicle display control device of the second aspect, the occupant can quickly grasp, just by checking the planned travel route of the vehicle displayed in the display area, whether or not the object of the lane change is passing.

In a third aspect of the disclosure, in the first aspect, for a lane change with the object of passing a vehicle in front, the vehicle display control device displays the planned travel route so that a leading end thereof gradually becomes fainter.

In the vehicle display control device of the third aspect, at least one of characters and an icon is displayed in the display area, so the occupant can directly grasp the object of the lane change.

In a forth aspect of the disclosure, in the first aspect, the vehicle display control device may display an object of the lane change in the display area using at least one of characters or an icon.

In the vehicle display control device of the forth aspect, a distinction can be made between a lane change for heading to a freeway exit and a lane change for approaching a branch road in addition to a lane change with the object of passing a vehicle in front.

A fifth aspect of the present disclosure, in the second aspect, among lane changes with objects other than passing, the vehicle display control device varies the information displayed in the display area between a lane change for heading to a freeway exit and a lane change for approaching a branch road.

In the vehicle display control device of the fifth aspect, the occupant can grasp the object of the lane change just by looking at the leading end of the planned travel route displayed in the display area.

A sixth aspect of the present disclosure, in the fifth aspect, at a time of a lane change for heading to a freeway exit, the vehicle display control device displays a leading end of the planned travel route in a shape of an arrow.

In the vehicle display control device of the sixth aspect, the occupant can grasp the object of the lane change just by looking at the leading end of the planned travel route displayed in the display area.

A seventh aspect of the present disclosure is a vehicle display control system including the vehicle display control device of any one of claims 1 to 7; and a display device that displays the information relating to the lane change in the display area.

In the vehicle display control system of the seventh aspect, the vehicle display control device causes the display device to display the information relating to the lane change in the display area. At this time, the vehicle display control device varies the information displayed in the display area in accordance with the object of the lane change, so the occupant can easily check the object of the lane change.

An eighth aspect of the present disclosure, in the seventh aspect, the display device is a head-up display device capable of projecting images onto a windshield glass.

In the vehicle display control system of the eighth aspect, images are projected by the head-up display device onto the windshield glass, so the occupant can check the object of the lane change in a state in which the occupant's line of sight is pointed forward.

A vehicle pertaining to a ninth aspect includes the vehicle display control system of the eighth aspect.

A vehicle display control method pertaining to a tenth aspect determines whether or not a lane change is necessary based on at least one of a planned travel route or area conditions and, in a case in which a lane change is necessary, displays information relating to the lane change in a display area in a vicinity of a driver's seat, wherein the vehicle display control method varies the information displayed in the display area between a lane change with an object of passing a vehicle in front and lane changes with objects other than passing.

A non-transitory storage medium pertaining to an eleventh aspect stores a program executable by a computer to execute a process, the process including: determining whether or not a lane change is necessary based on at least one of a planned travel route or area conditions; in a case in which a lane change is necessary, displaying information relating to the lane change in a display area in a vicinity of a driver's seat; and varying the information displayed in the display area between a lane change with an object of passing a vehicle in front and lane changes with objects other than passing.

As described above, according to the vehicle display control device, the vehicle display control system, the vehicle, the vehicle display control method, and the non-transitory storage medium storing a program pertaining to the present disclosure, an occupant can quickly grasp a lane change situation.

### BRIEF DESCRIPTION OF THE DRAWINGS

An exemplary embodiment of the present disclosure will be described in detail based on the following figures, wherein:

FIG. 1 is schematic view illustrating, from a vehicle rear side, a front portion of a cabin in a vehicle to which a vehicle display control device pertaining to the embodiment has been applied;

FIG. 2 is a block diagram illustrating hardware configurations of the vehicle display control device pertaining to the embodiment;

FIG. 3 is a block diagram illustrating functional configurations of the vehicle display control device pertaining to the embodiment;

FIG. 4 is a view illustrating a display example in a display area in the embodiment, and is a display example at the time of a lane change with the object of passing a vehicle in front;

FIG. 5 is a view illustrating a display example in a display area in the embodiment, and is a display example at the time of a lane change for approaching a branch road;

FIG. 6 is a view illustrating a display example in a display area in the embodiment, and is a display example at the time of a lane change for heading to a freeway exit;

FIG. 7 is a view illustrating a display example in a display area in the embodiment, and is a display example at the time of a lane change for avoiding an obstacle; and

FIG. 8 is a flowchart illustrating an example of a flow of a display process in the embodiment.

### DETAILED DESCRIPTION

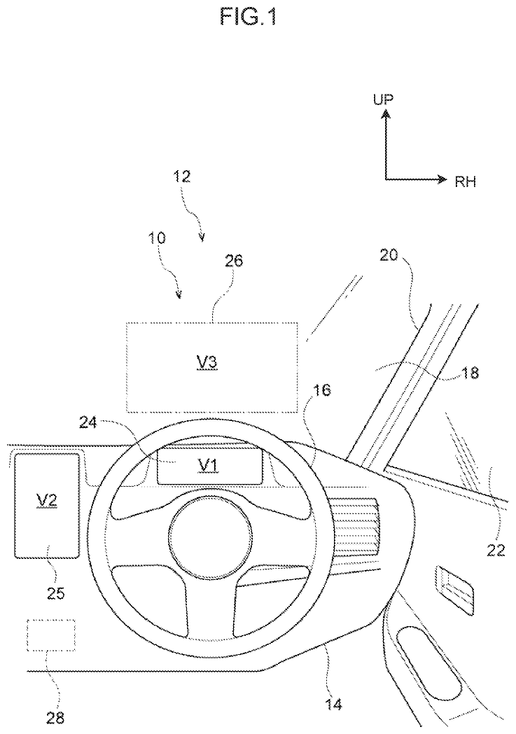

A vehicle display control system 10 including a vehicle display control device 28 pertaining to an embodiment will now be described with reference to the drawings. It will be noted that arrow UP in FIG. 1 indicates an upward direction in a vehicle up and down direction and arrow RH indicates a rightward direction in a vehicle width direction. “Up and down direction” and “right and left direction” in the following description mean up and down in the vehicle up and down direction and left and right in the vehicle width direction, respectively.

As illustrated in FIG. 1, a front portion of a cabin in a vehicle 12 is provided with an instrument panel 14. The instrument panel 14 extends in the vehicle width direction, and a steering wheel 16 is provided on the vehicle right side of the instrument panel 14. That is, in the present embodiment, as an example, the vehicle 12 is a right-hand-drive car where the steering wheel 16 is provided on the right side, and the driver's seat is set on the vehicle right side. It will be noted that the disclosure is not limited to this and may also be applied to a vehicle where the driver's seat is set on the vehicle left side.

On the front end portion of the instrument panel 14, a windshield glass 18 is provided. The windshield glass 18 extends in the vehicle up and down direction and the vehicle width direction and partitions the cabin interior from the cabin exterior.

The vehicle right-side end portion of the windshield glass 18 is secured to a front pillar 20 on the vehicle right side. The front pillar 20 extends in the vehicle up and down direction, and the windshield glass 18 is secured to the vehicle width direction inner end portion of the front pillar 20. Furthermore, a front end portion of a front side glass 22 is secured to the vehicle width direction outer end portion of the front pillar 20. It will be noted that the vehicle left-side end portion of the windshield glass 18 is secured to a front pillar on the vehicle left side (not illustrated in the drawings).

Here, the instrument panel 14 is provided with a first display unit 24 including a display area V1 for images. The first display unit 24 is configured by a meter display provided on the vehicle front side of the driver's seat on the vehicle right side of the instrument panel 14. The first display unit 24 is connected to various types of meters installed in the vehicle 12 and is provided in a position within the field of view of a driver when the driver's line of sight is pointed in the vehicle forward direction.

The instrument panel 14 is also provided with a second display unit 25 including a display area V2 for images. The second display unit 25 is configured by a center display disposed in the vehicle width direction central portion of the instrument panel 14.

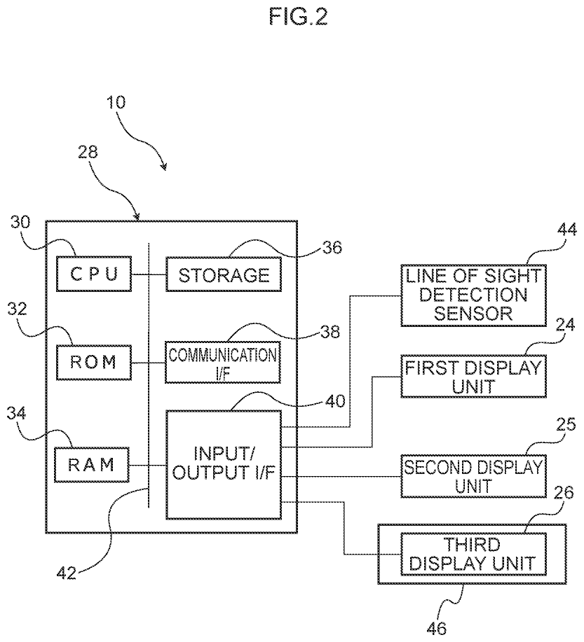

The windshield glass 18 is provided with a third display unit 26 having a display area V3 for images. The third display unit 26 is provided on the vehicle upper side of the first display unit 24 and is configured by a projection surface projected by a head-up display device 46 serving as a display device (see FIG. 2). Specifically, the head-up display device 46, which can project images, is provided on the vehicle front side of the instrument panel 14 and is configured so that images are projected from the head-up display device 46 to the third display unit 26 of the windshield glass 18. That is, the third display unit 26 is a part of the windshield glass 18 configured to serve as the projection surface of the head-up display device 46.

Here, the vehicle 12 is provided with a vehicle display control device 28 configuring the vehicle display control system 10. The vehicle display control device 28 of the present embodiment is, for example, an electronic control unit (ECU) that performs various types of control.

### (Hardware Configurations of Vehicle Display Control Device 28)

As illustrated in FIG. 2, the vehicle display control device 28 is configured to include a central processing unit (CPU, processor) 30, a read-only memory (ROM) 32, a random-access memory (RAM) 34, a storage 36, a communication interface (I/F) 38, and an input/output interface (I/F) 40. These configurations are communicably connected to each other via an internal bus 42.

The CPU 30 is a central arithmetic processing unit, executes various types of programs, and controls each part of the vehicle display control device 28. That is, the CPU 30 reads programs from the ROM 32 or the storage 36 and executes the programs using the RAM 34 as a workspace. Furthermore, the CPU 30 controls each of the above configurations and performs various types of arithmetic processing in accordance with programs recorded in the ROM 32 or the storage 36.

The ROM 32 stores various types of programs and various types of data. The RAM 34 temporarily stores programs or data as a workspace. The storage 36 is configured by a hard disk drive (HDD) or a solid-state drive (SSD) and is a non-transitory recording medium that stores various types of programs, including an operating system, and various types of data. In the present embodiment, a display program for performing a display process is stored in the ROM 32 or the storage 36.

The communication interface 38 is an interface for the vehicle display control device 28 to communicate with a server and other devices and, for example, uses a standard such as Controller Area Network (CAN), Ethernet (registered trademark), Long-Term Evolution (LTE), Fiber Distributed Data Interface (FDDI), or Wi-Fi (registered trademark).

To the input/output interface 40 are connected a line of sight detection sensor 44, the first display unit 24, the second display unit 25, and the head-up display device 46. Furthermore, images are projected by the head-up display device 46 to the third display unit 26.

The line of sight detection sensor 44 is, for example, provided in the instrument panel 14 and is disposed facing the face of an occupant (driver) sitting in the driver's seat. The light of sight detection sensor 44 detects the direction of the occupant's line of sight using a principle such as corneal reflection or sclera reflection by perceiving the eyes of the occupant.

### (Functional Configurations of Vehicle Display Control Device 28)

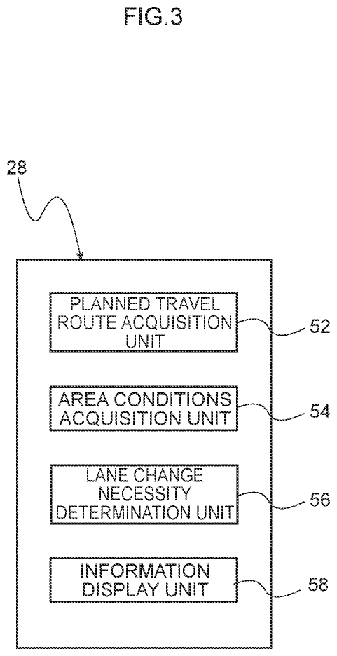

The vehicle display control device 28 uses the above hardware resources to realize various types of functions. Functional configurations realized by the vehicle display control device 28 will now be described using FIG. 3.

As illustrated in FIG. 3, the vehicle display control device 28 is configured to include, as functional configurations, a planned travel route acquisition unit 52, an area conditions acquisition unit 54, a lane change necessity determination unit 56, and an information display unit 58. It will be noted that each functional configuration is realized by the CPU 30 reading and executing programs stored in the ROM 32 or the storage 36.

The planned travel route acquisition unit 52 acquires information relating to a planned travel route that has been set by a navigation system or the like. For example, a planned travel route to a destination may be set by the occupant inputting the destination to the navigation system or the like. The planned travel route includes information relating to planned travel roads and position information relating to intersections at which the vehicle 12 will change course by, for example, making right or left turns. Furthermore, when the planned travel route includes a freeway, it includes position information relating to branch roads and position information relating to freeway entrances and exits.

It will be noted that the planned travel route may be stored in a storage or the like installed in the vehicle 12 or may be stored outside the vehicle 12 such as on a server. When the planned travel route is stored in a storage in the vehicle 12, the planned travel route acquisition unit 52 acquires information relating to the planned travel route by accessing the storage. Furthermore, when the planned travel route is stored on a server or the like outside the vehicle 12, the planned travel route 52 may acquire the planned travel route from the server via the communication interface 38.

The area conditions acquisition unit 54 acquires area conditions around the vehicle 12 based on signals from multiple sensors installed in the vehicle 12. For example, installed in the vehicle 12 are cameras such as a front camera that captures images forward of the vehicle, a rear camera that captures images rearward of the vehicle, and side cameras that capture images sideward of the vehicle. Also installed in the vehicle 12 are radar sensors for detecting obstacles around the vehicle 12. The area conditions acquisition unit 54 acquires, based on the signals received from these cameras and radar sensors, information relating to other vehicles driving in the vicinity of the vehicle 12 and information relating to obstacles or the like.

The lane change necessity determination unit 56 determines whether or not a lane change is necessary based on at least one of the planned travel route and the area conditions. For example, the lane change necessity determination unit 56 determines, based on information relating to the planned travel route acquired by the planned travel route acquisition unit 52, that a lane change is necessary when, in a situation where the vehicle 12 is approaching a point at which it needs to make a right or left turn, the vehicle 12 is driving in a lane different from the lane in which the vehicle 12 needs to be to make the right or left turn.

Furthermore, when, in a situation such as when the vehicle 12 is approaching the point of entry to a branch road, the vehicle 12 is driving in a lane that is not adjacent to the branch road, the lane change necessity determination unit 56 determines that a lane change to the lane adjacent to the branch road is necessary.

Moreover, when, in a situation where the vehicle 12 is approaching a freeway entrance or exit, the vehicle 12 is driving in a lane different from the lane leading to the entrance or exit, the lane change necessity determination unit 56 determines that a lane change the lane leading to the entrance or exit is necessary.

Moreover still, when the speed of a vehicle driving in front of the vehicle 12 is slow, the lane change necessity determination unit 56 determines, from the area conditions around the vehicle 12 acquired by the area conditions acquisition unit 54, that a lane change with the object of passing is necessary. For example, consider a state in which adaptive cruise control (ACC), which is a driver assistance function, is on. In such a state, when the speed of a vehicle in front is slower than the set speed of the ACC and the distance headway to the vehicle in front is less than a predetermined distance, the lane change necessity determination unit 56 may determine that a lane change with the object of passing is necessary.

Furthermore, when an obstacle such as a fallen object has been detected ahead in the driving lane, the lane change necessity determination unit 56 determines, from the area conditions around the vehicle 12 acquired by the area conditions acquisition unit 54, that a lane change for avoiding the obstacle is necessary.

When a lane change is necessary, the information display unit 58 displays information relating to the lane change in a display area in the vicinity of the driver's seat. Specifically, when it has been determined by the function of the lane change necessity determination unit 56 that a lane change is necessary, the information display unit 58 displays information relating to the lane change in at least one display area among the display area V1, the display area V2, and the display area V3.

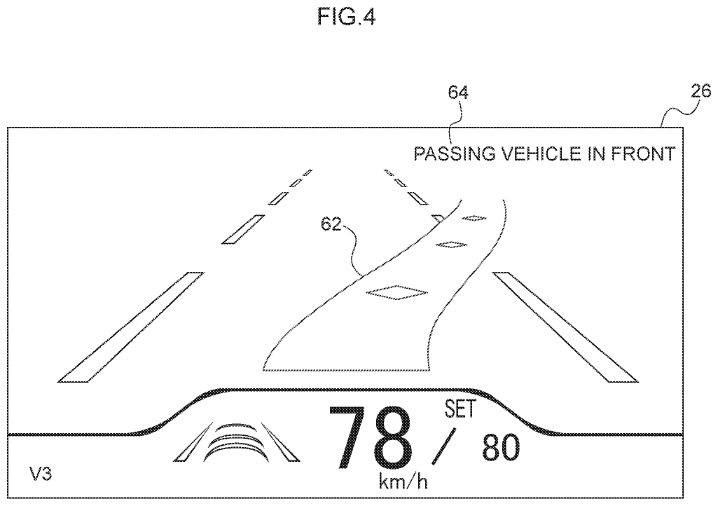

Here, in the present embodiment, the information display unit 58 varies the displayed information in accordance with the object of the lane change. Display examples of lane changes displayed by the information display unit 58 will now be described with reference to FIG. 4 to FIG. 7. It will be noted that in FIG. 4 to FIG. 7, the vehicle 12 is driving on a freeway and the ACC, which is a driver assistance function, is on. For this reason, the lane changes by the vehicle 12 are executed by the system. Furthermore, the display examples in FIG. 4 to FIG. 7 are only examples, and that which is displayed by the information display unit 58 is not limited to these examples.

FIG. 4 is a view illustrating a display example in the display area V3 in the present embodiment, and is a display example at the time of a lane change with the object of passing a vehicle in front.

As illustrated in FIG. 4, in the lower portion of the display area V3 are displayed the set speed of the ACC and the current vehicle speed. Furthermore, on the left side of the vehicle speed is displayed an icon indicating that the ACC is on. It will be noted that the display in the lower portion of the display area V3 is not particularly limited, and information different from the information illustrated in FIG. 4 may also be displayed.

In the center of the display area V3 is displayed a planned travel route 62 of the vehicle 12, and the information display unit 58 makes the occupant aware of the object of the lane change by varying the display mode of the planned travel route 62. In FIG. 4, the planned travel route 62 is heading to the lane adjacent to the right side of the driving lane, and it is suggested that a lane change to the right lane will be performed. Furthermore, the leading end of the planned travel route 62 is displayed so as to gradually become fainter.

It will be noted that in FIG. 4, three diamonds are spaced apart from each other on the planned travel route 62 and displayed so that the spacing between the diamonds is varied in accordance with the vehicle speed, but the information display unit 58 is not limited to this and need not display the diamonds.

In the upper right of the display area V3, the object of the lane change is indicated by characters 64. In FIG. 4, it is displayed that the lane change is a lane change for passing a vehicle in front.

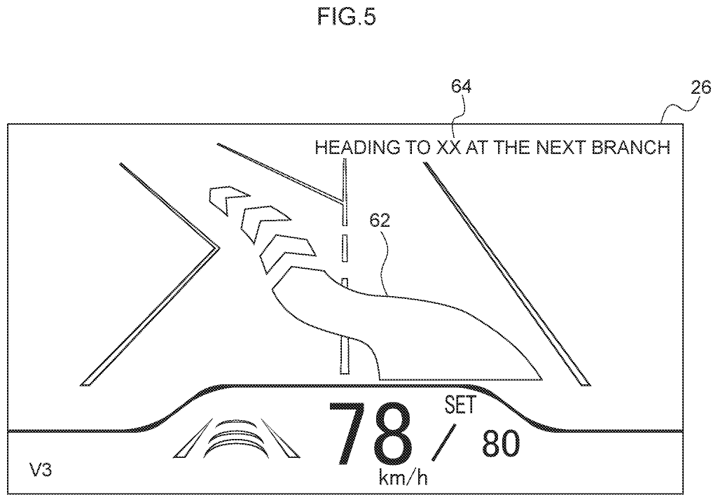

FIG. 5 is a view illustrating a display example in the display area V3 in the present embodiment, and is a display example at the time of a lane change for approaching a branch road.

As illustrated in FIG. 5, at the time of a lane change for approaching a branch road, the leading end of the planned travel route 62 extends toward the branch road, and the leading end of the planned travel route 62 is displayed discontinuously.

In the upper right of the display area V3, the object of the lane change is indicated by characters 64. In FIG. 5, it is displayed that the lane change is a lane change for approaching a branch road.

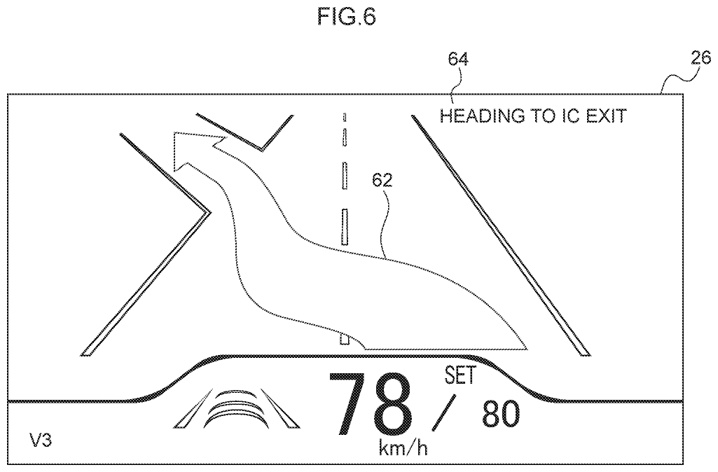

FIG. 6 is a view illustrating a display example in the display area V3 in the present embodiment, and is a display example at the time of a lane change for heading to a freeway exit.

As illustrated in FIG. 6, at the time of a lane change for heading to a freeway exit, the leading end of the planned travel route 62 extends in a direction leading to the exit, and the leading end of the planned travel route 62 is displayed in the shape of an arrow.

In the upper right of the display area V3, the object of the lane change is indicated by characters 64. In FIG. 6, it is displayed that the lane change is a lane change for heading to a freeway exit.

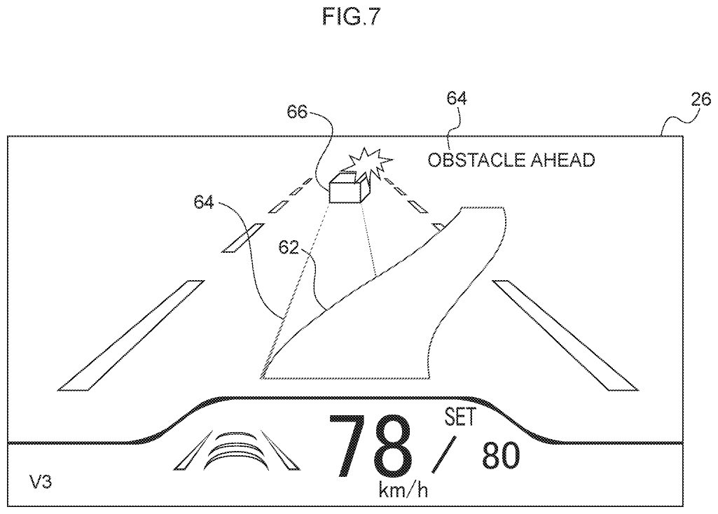

FIG. 7 is a view illustrating a display example in the display area V3 in the present embodiment, and is a display example at the time of a lane change for avoiding an obstacle.

As illustrated in FIG. 7, at the time of a lane change for avoiding an obstacle, the planned travel route 62 heads to a lane adjacent to the right side of the driving lane, and it is suggested that a lane change to the right lane will be performed. Furthermore, the leading end of the planned travel route 62 is displayed so as to gradually become fainter. Moreover, an original planned travel route 64 is displayed so as to be toned down. Furthermore, an image 66 resembling an obstacle may also be displayed in the display area V3.

### (Operation)

Next, the action of the present embodiment will be described.

### (Display Process)

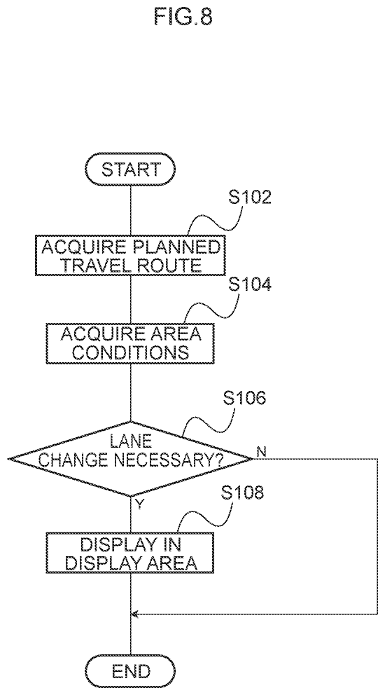

An example of a display process for causing the third display unit 26, which is the projection surface of the head-up display device 46, to display information relating to lane changes will now be described using the flowchart illustrated in FIG. 8. The display process is executed by the CPU 30 reading a display program from the ROM 32 or the storage 36, loading it to the RAM 34, and executing it. It will be noted that in the present embodiment, as an example, the display process is executed at predetermined intervals when the vehicle 12 is driving on a freeway and the ACC is on.

In step S102 the CPU 30 acquires information relating to the planned travel route. Specifically, the CPU 30 uses the function of the planned travel route acquisition unit 52 to acquire the planned travel route of the vehicle 12. For example, the CPU 30 may acquire just the planned travel route up to the time of an upcoming event when a lane change will become necessary.

In step S104 the CPU 30 acquires the area conditions. Specifically, the CPU 30 uses the function of the area conditions acquisition unit 54 to acquire the area conditions around the vehicle 12.

In step S106 the CPU 30 determines whether or not the vehicle 12 needs to make a lane change. Specifically, the CPU 30 uses the function of the lane change necessity determination unit 56 to determine whether or not a lane change is necessary based on the information acquired by the planned travel route acquisition unit 52 and the information acquired by the area conditions acquisition unit 54.

The CPU 30 moves to the process of step S108 when it determines in step $106 that a lane change is necessary. The CPU 30 ends the display process when it determines in step S106 that a lane change is not necessary.

In step S108 the CPU 30 displays information relating to the lane change in a predetermined display area. In the present embodiment, the CPU 30 uses the function of the information display unit 58 to display in the display area V3 of the third display unit 26 an indication that a lane change will be performed. Specifically, the CPU 30 displays in the display area V3 the planned travel route 62 and the characters 64 indicating the lane change (see FIG. 4 to FIG. 7). At this time, the CPU 30 varies the information displayed in the display area V3 in accordance with the object of the lane change. Then, the CPU 30 ends the display process.

It will be noted that after the information relating to the lane change is displayed, control of the steering wheel and the acceleration pedal is performed by driver assistance functions installed in the vehicle 12 so that the vehicle 12 executes a lane change along the planned travel route 62.

As described above, in the vehicle display control system 10 including the vehicle display control device 28 pertaining to the present embodiment, whether or not a lane change is necessary is determined based on at least one of the planned travel route of the vehicle 12 and the area conditions around the vehicle 12. Furthermore, when a lane change is necessary, the information relating to the lane change is displayed in the display area V3 in the vicinity of the driver's seat. Because of this, when the vehicle 12 performs a lane change using driver assistance or the like, the occupant can be notified that a lane change will be performed.

Furthermore, in the present embodiment, the vehicle display control device 28 varies the information displayed in the display area V3 between a lane change with the object of passing a vehicle in front, such as illustrated in FIG. 4, and lane changes with objects other than passing, such as illustrated in FIG. 5 to FIG. 7. Because of this, the occupant can quickly grasp, just by checking the information displayed in the display area V3, whether or not the object of the lane change is passing.

In particular, in the present embodiment, the vehicle display control device 28 varies the display mode of the planned travel route 62 in accordance with the object of the lane change, so the occupant can quickly grasp, just by checking the planned travel route 62 of the vehicle displayed in the display area V3, whether or not the object of the lane change is passing.

Moreover, in the present embodiment, at least one of characters and an icon indicating the object of the lane change is displayed in the display area V3, so the occupant can directly grasp the object of the lane change.

Moreover still, in the present embodiment, a distinction can be made between a lane change for heading to a freeway exit and a lane change for approaching a branch road in addition to a lane change with the object of passing a vehicle in front. In particular, the occupant can grasp the object of the lane change just by looking at the leading end of the planned travel route 62 displayed in the display area V3.

The vehicle display control system 10, the vehicle display control device 28, and the vehicle 12 pertaining to the embodiment have been described above, but they can of course be implemented in a variety of ways without departing from the spirit of the present disclosure. For example, in the above embodiment, a configuration that displays the information relating to the lane change in the display area V3 of the third display unit 26 was described, but the disclosure is not limited to this. For example, the disclosure may also employ a configuration that displays the information relating to the lane change in the display area V1 of the first display unit 24 or the display area V2 of the second display unit 25.

Furthermore, the information relating to the lane change may be displayed in multiple display areas among the display area V1, the display area V2, and the display area V3.

Moreover, when displaying the information in the display area V3, the information relating to the lane change may be superimposed on the foreground visible through the windshield glass 18 and displayed. The superimposed display can be performed using existing augmented reality (AR) technology; for example, the direction of the occupant's line of sight may be detected by the line of sight detection sensor 44, and the display position of the information may be adjusted based on the direction of the line of sight.

Moreover still, in the above embodiment, the occupant was made aware that the objects of the lane changes are different by changing the shape of the planned travel route 62, but the disclosure is not limited to this. For example, the color and the size of the planned travel route 62 may also be varied. Furthermore, the object of the lane change may be displayed using only the characters 64 without changing the mode of the planned travel route 62 itself. Here, the display position and the size of the characters 64 are not limited.

Furthermore, in the above embodiment, just an image resembling a lane and the planned travel route 62 were displayed in the display area V3, but the disclosure is not limited to this, and an image resembling the host vehicle may also be added. In this case, the host vehicle becomes displayed using a third person perspective, and it becomes easier for the occupant to grasp the planned travel route of the host vehicle.

Moreover, in the above embodiment, the lane change necessity determination unit 56 determined whether or not a lane change is necessary based on at least one of the information relating to the planned travel route acquired by the planned travel route acquisition unit 52 and the area conditions around the vehicle 12 acquired by the area conditions acquisition unit 54, but the lane change necessity determination unit 56 is not limited to this. For example, the lane change necessity determination unit 56 may also determine whether or not a lane change is necessary based on just the information relating to the planned travel route acquired by the planned travel route acquisition unit 52. Furthermore, the lane change necessity determination unit 56 may determine whether or not a lane change is necessary based on just the area conditions around the vehicle 12 acquired by the area conditions acquisition unit 54.

Furthermore, the processes that the CPU 30 executed by reading a program in the above embodiment may also be executed by various types of processors other than the CPU 30. Examples of processors in this case include programmable logic devices (PLDs) whose circuit configuration can be changed after manufacture, such as field-programmable gate arrays (FPGAs), and dedicated electrical circuits that are processors having a circuit configuration dedicatedly designed for executing specific processes, such as application-specific integrated circuits (ASICs). Furthermore, the processes may be executed by one of these various types of processors, or may be executed by a combination of two or more processors of the same type or different types, or, for example, may be executed by plural FPGAs and a combination of a CPU and an FPGA. Furthermore, the hardware structures of these various types of processors are more specifically electrical circuits in which circuit elements such as semiconductor elements are combined.

Moreover, in the above embodiment, various types of data were stored in the storage 36, but the disclosure is not limited to this. For example, a non-transitory recording medium such as a compact disc (CD), a digital versatile disc (DVD), and a universal serial bus (USB) memory may also serve as a storage unit. In this case, various types of programs and data become stored in these recording media.

Moreover still, the flow of processes described in the above embodiment is an example, and unnecessary steps may be omitted therefrom, new steps may be added thereto, and/or the process order may be changed without departing from the spirit thereof.

Furthermore, the display process described in the above embodiment can be applied both during autonomous driving of a vehicle capable of autonomous driving and during manual driving of a vehicle capable of autonomous driving. Furthermore, the display process can be applied both during manual driving of a vehicle capable only of manual driving and during autonomous driving of a vehicle capable only of autonomous driving.

What is claimed is:

1. A vehicle display control device that determines whether or not a lane change is necessary based on at least one of a planned travel route or area conditions and, in a case in which a lane change is necessary, displays information relating to the lane change in a display area in a vicinity of a driver's seat, wherein the vehicle display control device comprises a processor, and the processor is configured to vary the information displayed in the display area between a lane change with an object of passing a vehicle in front and lane changes with objects other than passing.

2. The vehicle display control device of claim 1, wherein the processor varies a display mode of the planned travel route of the vehicle between a lane change with the object of passing a vehicle in front and lane changes with objects other than passing.

3. The vehicle display control device of claim 2, wherein, for a lane change with the object of passing a vehicle in front, the processor displays the planned travel route so that a leading end thereof gradually becomes fainter.

4. The vehicle display control device of claim 1, wherein the processor displays an object of the lane change in the display area using at least one of characters or an icon.

5. The vehicle display control device of claim 2, wherein, among lane changes with objects other than passing, the processor varies the information displayed in the display area between a lane change for heading to a freeway exit and a lane change for approaching a branch road.

6. The vehicle display control device of claim 5, wherein, at a time of a lane change for heading to a freeway exit, the processor displays a leading end of the planned travel route in a shape of an arrow.

7. The vehicle display control device of claim 5, wherein, at a time of a lane change for approaching a branch road, the processor displays a leading end of the planned travel route discontinuously.

8. A vehicle display control system comprising:
the vehicle display control device of claim 1; and
a display device that displays the information relating to the lane change in the display area.

9. The vehicle display control system of claim 8, wherein the display device is a head-up display device capable of projecting images onto a windshield glass.

10. A vehicle including the vehicle display control system of claim 9.

11. A vehicle display control method, comprising, by a processor:
determining whether or not a lane change is necessary based on at least one of a planned travel route or area conditions;
in a case in which a lane change is necessary, causing display of information relating to the lane change in a display area in a vicinity of a driver's seat; and
varying the information displayed in the display area between a lane change with an object of passing a vehicle in front and lane changes with objects other than passing.

12. A non-transitory storage medium storing a program executable by a computer to perform processing, the processing including:
determining whether or not a lane change is necessary based on at least one of a planned travel route or area conditions;
in a case in which a lane change is necessary, displaying information relating to the lane change in a display area in a vicinity of a driver's seat; and
varying the information displayed in the display area between a lane change with an object of passing a vehicle in front and lane changes with objects other than passing.
